(19) United States
(12) Patent Application Publication
(10) Pub. No.: US 2017/0174096 A1
(43) Pub. Date: Jun. 22, 2017

(54) FEEDBACK FOR CONTROL OF A WHEEL HUB MOTOR

(71) Applicant: Zack Z. Wang, Santa Clara, CA (US)

(72) Inventor: Zack Z. Wang, Santa Clara, CA (US)

(21) Appl. No.: 14/972,620

(22) Filed: Dec. 17, 2015

(51) Int. Cl. B60L 15/02; G01D 5/347; B60K 7/00

(52) U.S. Cl. CPC B60L 15/02; B60K 7/0007; G01D 5/3473; B60K 2007/0092; B60L 2240/429

(57) ABSTRACT

A wheel assembly includes an optical detector and encoder, attached to a stator and located within a hub of the wheel assembly. The optical detector and encoder detects motion of the hub and encodes information about the detected motion of the hub. Based on the encoded information, the optical detector and encoder produces a feedback signal for control circuitry that controls rotation of the wheel.

### BACKGROUND

A wheel hub motor is an electric motor that is incorporated within the hub of a wheel and directly drives the wheel.

A rotor is attached to the hub of the wheel. Energy is transferred from a stator to the rotor. For example, stationary windings are located on the stator. The energy is transferred to the rotor through a magnetic field, which is generated by the permanent magnets attached on the rotor. The rotor is supported by two bearings on the shaft of the motor.

In an inner rotation motor configuration, the rotor sits inside the stator. In an outer-rotation motor, the rotor is located outside the stator and rotates around it.

Wheel hub motors have many uses such as for electric bikes, electric scooters, automobiles and robotics.

### BRIEF DESCRIPTION OF THE DRAWINGS

FIG. 1 shows the exterior of a wheel assembly that includes a wheel and a wheel hub motor in accordance with an implementation.

FIG. 2 shows a partially disassembled view of the wheel assembly shown FIG. 1 in accordance with an implementation.

FIG. 3 shows a simplified cross-section view of the wheel assembly shown FIG. 1 in accordance with an implementation.

### DESCRIPTION OF THE EMBODIMENT

A wheel assembly includes an optical detector and encoder, attached to a stator and located within a hub of the wheel assembly. The optical detector and encoder detects the motion of the hub and encodes information about the detected motion of the hub. Based on the encoded information, the optical detector and encoder produces a feedback signal for control circuitry that controls rotation of the wheel.

For example, an encoder code wheel is attached to the hub. The encoder code wheel has first sections that are less reflective than second sections. The encoder code wheel is located on the hub so that as the wheel rotates, the optical detector and encoder detects motion of the hub by noting light reflecting from the encoder code wheel. The light reflects at a different intensity depending upon whether the light is reflecting from one of the first sections or from one of the second sections.

For example, the second sections are reflective stainless steel and the first sections are lines carved in the reflective stainless steel. Alternatively, the first sections are black and the second sections are white.

For example, the optical detector and encoder includes an optical beam generator and a light sensor. The generated optical beam is reflected by the encoder code wheel to the light sensor.

For example, the feedback signal is a two-phase quadrature A/B pulse feedback signal. For example, the hub is composed of a first motor end bell and a second motor end bell that each rotate around a shaft. For example, a rotor connected to the hub is located outside the stator and rotates around the stator.

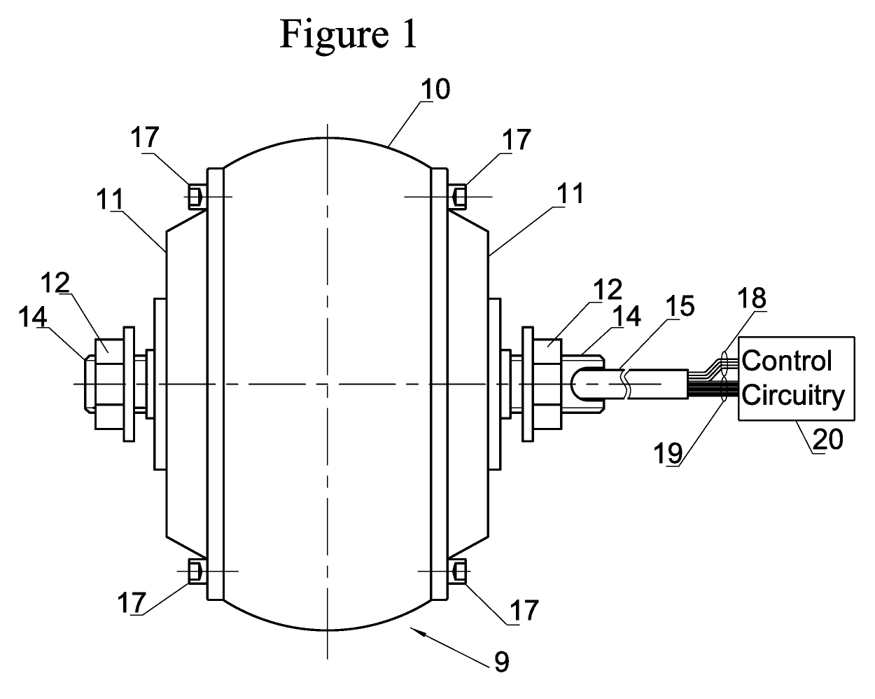

FIG. 1 shows the exterior of a wheel assembly 9 that includes a wheel 10 driven by a wheel hub motor. For example wheel 10 is composed of rubber, plastic or some other suitable material. A wheel hub, consisting of two end bells 11, is attached to wheel 10, for example, using screws 17. Wheel 10, with end bells 11 supported by two bearings 13, rotates around shaft 14. Nuts 12 screw onto a shaft 14 and may be used to mount wheel assembly 9 onto a device, such as a cart or a robotics device.

A cable 15 is used to supply power signals from control circuitry 20 to the wheel hub motor as well as to receive feedback information from the wheel hub motor. For example, power wires 18 represent wires used to provide current to power the wheel hub motor and control wires 19 represent wires used to feedback information to control circuitry 20. Cable 15 can also be used to supply control signals to the wheel hub motor.

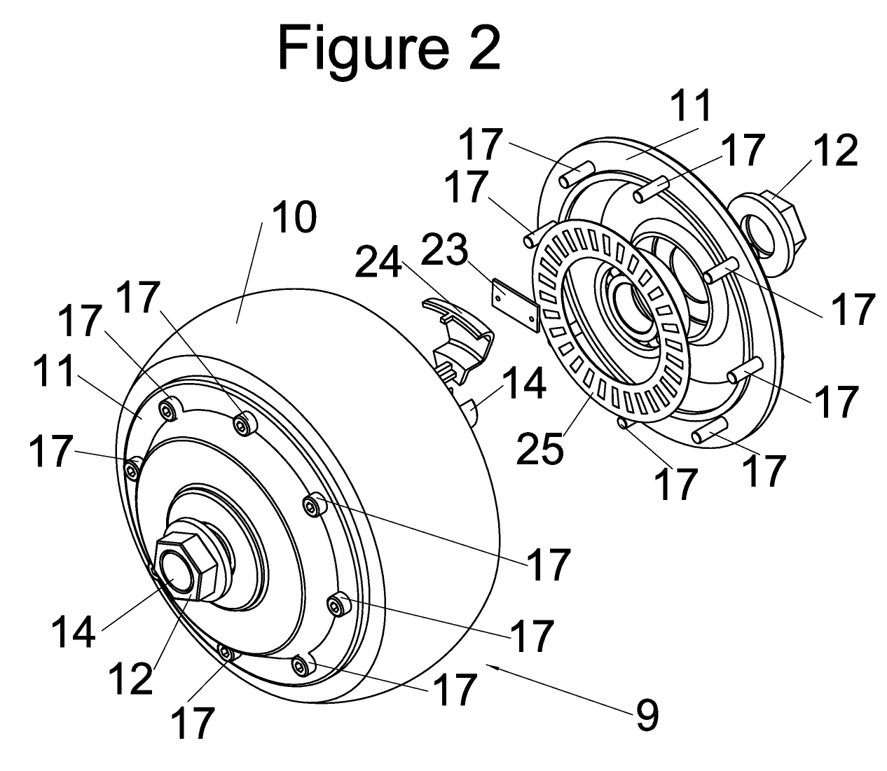

FIG. 2 shows a partially disassembled view of wheel assembly 9. A rotor 21 is shown attached to wheel 10. An encoder code wheel 25 is attached to one of end bell 11 and rotates with wheel 10 around shaft 14. A mounting base 24 is mounted on stator 22. A detect circuit board 23 is placed on mounting base 24. Detect circuit board 23 includes an optical detector and encoder. For example, a glue such as Locktite super glue may be used to attach detector circuit board 23 to mounting base 24 and mounting base 24 to stator 22. For example, mounting base 24 is composed of plastic or some other material suitable for mounting detect circuit board 23. As wheel 10 rotates along with encoder code wheel 25, detect circuit board 23 detects feedback information about the movement and transmits the feedback information to external control circuitry 20 through control wires 19.

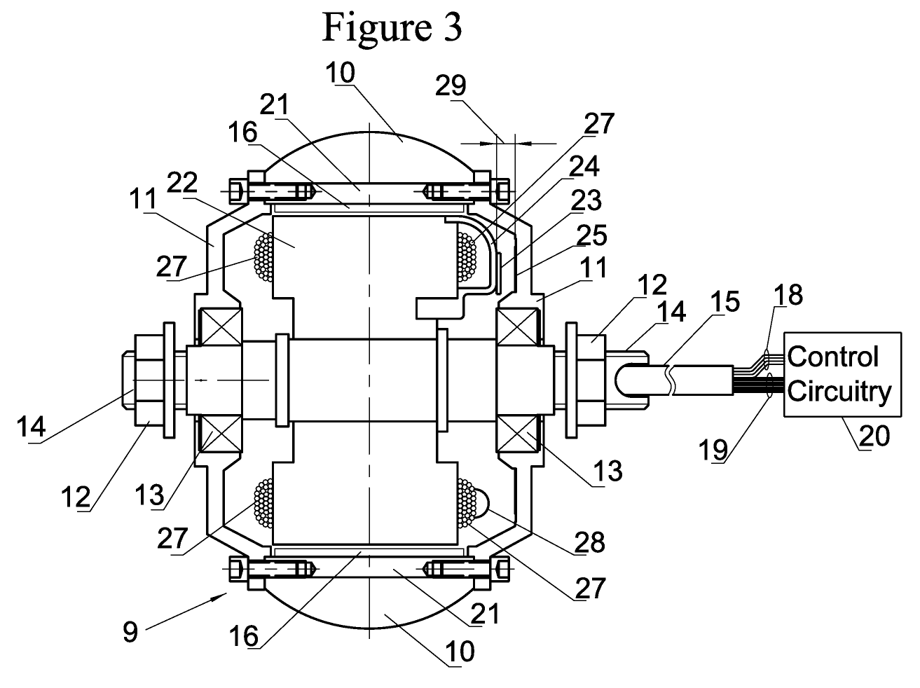

FIG. 3 shows a simplified cross-section view of wheel assembly 9. A clearance space 29 between encoder code wheel 25 and detect circuit board 23 is, for example, 4.5 millimeters.

For example, stator 22 and rotor 21 function as an outer-rotation wheel hub motor. Stationary windings 27 on stator 22 provide energy that is transferred to rotor 21—via the magnetic field generated by permanent magnets 16—to drive wheel 10. Current through the stationary windings is provided from control circuitry 20 through power wires 18 shown in FIG. 1. A thermal sensor 28 monitors heat within wheel assembly 9.

While FIG. 2 and FIG. 3 show that the hub motor is In an outer-rotation configuration so that rotor 21 is located outside stator 22 and rotates around stator 22, other configurations can be utilized. For example, the hub motor could be configured In an inner rotation motor configuration, where the rotor sits inside the stator. Alternatively, the hub motor could be configured in an axial-flux motor configuration where the stator windings are sandwiched between sets of magnets.

For example, encoder code wheel 25 is composed of reflective stainless steel material with carved lines. The carved lines reflect detectably less light then the polished stainless steel material. The color and spacing of the carved lines as well as the background color are exemplary. What is important is being able to detect rotation of encoder code wheel 24 by optical encoder circuit board 23.

Alternatively, for example, encoder code wheel 25 is white material encoded with black lines. Alternatively, for example, encoder code wheel 25 is black material encoded with white lines. Other coloring schemes can be used, so long as rotation of encoder code wheel 24 is detectable by optical encoder circuit board 23.

For example, the optical beam generator and a light sensor on optical encoder circuit board 23 generates an optical beam that is reflected by encoder code wheel 25. Based on the reflected light, the light sensor is able to detect different light intensity based on whether the light is reflected by the background of the encoder code wheel 25 or by a carved line of encoder code wheel 25.

For example, when operating as a motion detector, optical encoder circuit board 23 will send a two-phase quadrature A/B pulse feedback signal to control circuitry 20 through control lines 19 whenever optical encoder circuit board 23 first detects a carved line of encoder code wheel 25. This feedback signal allows control circuitry 20 to monitor motion of wheel 10. By controlling current through power lines 18 control circuitry 20 can control direction and rotation speed of wheel 10. The feedback signal provided by optical encoder circuit board 23 allows control circuitry 20 to precisely monitor operation of wheel 10.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed is:

1. A wheel assembly comprising:
a shaft;
a hub that rotates around the shaft;
a wheel attached to the hub;
a stator located within the hub; and,
an optical detector and encoder, attached to the stator and located within the hub, the optical detector and encoder detecting motion of the hub and encoding information about the detected motion of the hub, wherein based on the encoded information, the optical detector and encoder produces a feedback signal for control circuitry that controls rotation of the wheel.

2. A wheel assembly as in claim 1, additionally comprising:
a rotor connected to the hub, the rotor being located outside the stator and rotating around the stator.

3. A wheel assembly as in claim 1, additionally comprising:
an encoder code wheel, attached to the hub, the encoder code wheel being composed of reflective stainless steel material with carved lines, the carved lines providing contrast, wherein the encoder code wheel is located on the hub so that as the wheel rotates, the optical detector and encoder detects motion of the hub by noting light reflecting from the encoder code wheel, the light reflecting at a different intensity depending upon whether the light is reflecting from the reflective stainless steel material or from the carved lines.

4. A wheel assembly as in claim 1, additionally comprising:
an encoder code wheel, attached to the hub, the encoder code wheel having first sections that are less reflective than second sections, wherein the encoder code wheel is located on the hub so that as the wheel rotates, the optical detector and encoder detects motion of the hub by noting light reflecting from the encoder code wheel, the light reflecting at a different intensity depending upon whether the light is reflecting from one of the first sections or from one of the second sections.

5. A wheel assembly as in claim 4, wherein the first sections are black and the second sections are white.

6. A wheel assembly as in claim 4, wherein the second sections are reflective stainless steel and the first sections are lines carved in the reflective stainless steel.

7. A wheel assembly as in claim 4 wherein the optical detector and encoder includes:
an optical beam generator; and
a light sensor, wherein the generated optical beam is reflected by the encoder code wheel to the light sensor.

8. A wheel assembly as in claim 4 wherein the optical detector and encoder includes:
an optical beam generator; and
a light sensor.

9. A wheel assembly as in claim 1 wherein the feedback signal is a two-phase quadrature A/B pulse feedback signal.

10. A wheel assembly as in claim 1 wherein the hub comprises:
a first motor end bell and a second motor end bell that each rotate around the shaft.

11. A method for controlling a wheel hub motor, comprising:
varying intensity and direction of current supplied to the wheel hub motor to control the wheel hub motor;
using an optical detector and encoder, attached to a stator of the wheel hub motor to detect motion of a hub and to encode information about the detected motion of the hub, including:
detecting motion of the hub by noting light reflecting from an encoder code wheel attached to the hub, the light reflecting at a different intensity depending upon whether the light is reflecting from one of first sections or from one of second sections, the second sections having higher reflectivity than the first sections, and
producing a feedback signal from the encoded information;
providing the feedback signal to control circuitry that controls intensity and direction of current supplied to the wheel hub motor; and,
using the feedback signal when determining how much to vary intensity of current supplied to the wheel hub motor.

12. A method as in claim 11, wherein the first sections are black and the second sections are white.

13. A method as in claim 11, wherein the second sections are reflective stainless steel and the first sections are lines carved in the reflective stainless steel.

14. A method as in claim 11, wherein the feedback signal is a two-phase quadrature A/B pulse feedback signal.

15. A wheel assembly comprising:
a hub;
a stator located within the hub;
an encoder code wheel, attached to the hub, the encoder code wheel having first sections that are less reflective than second sections; and,
an optical detector and encoder, attached to the stator and located within the hub, the optical detector and encoder detecting motion of the hub and encoding information about the detected motion of the hub, wherein based on the encoded information, the optical detector and encoder produces a feedback signal for control circuitry that controls rotation of the wheel;
wherein the encoder code wheel is located on the hub so that as the wheel rotates, the optical detector and encoder detects motion of the hub by noting light reflecting from the encoder code wheel, the light reflecting at a different intensity depending upon whether the light is reflecting from one of the first sections or from one of the second sections.

16. A wheel assembly as in claim 15, additionally comprising:
a rotor connected to the hub, the rotor being located outside the stator and rotating around the stator.

17. A wheel assembly as in claim 15, wherein the first sections are black and the second sections are white.

18. A wheel assembly as in claim 15, wherein the second sections are reflective stainless steel and the first sections are lines carved in the reflective stainless steel.

19. A wheel assembly as in claim 15 wherein the optical detector and encoder includes:
an optical beam generator, and
a light sensor, wherein the generated optical beam is reflected by the encoder code wheel to the light sensor.

20. A wheel assembly as in claim 15 wherein the feedback signal is a two-phase quadrature A/B pulse feedback signal.
